(19) United States
(12) Patent Application Publication
(10) Pub. No.: US 2007/0046110 A1
(43) Pub. Date: Mar. 1, 2007

(54) Power tool capable of battery status indication

(75) Inventor: Chang-Shin Liu, Chia-Yi City (TW)

Correspondence Address: LADAS & PARRY, 26 WEST 61ST STREET, NEW YORK, NY, 10023, US

(73) Assignee: AEBOS TECHNOLOGY CO., LTD.

(21) Appl. No.: 11/301,159

(22) Filed: Dec. 12, 2005

(30) Foreign Application Priority Data
Aug. 24, 2005 (TW) 94214526

(51) Int. Cl. B23B 49/00

(52) U.S. Cl. 310/50; 408/16

(57) ABSTRACT

A power tool includes a housing, a battery-operated power supplying unit, a driving unit, and a battery status indicator. The power supplying unit is mounted in the housing, is adapted to be connected to a battery unit, and includes a processor unit capable of monitoring status of the battery unit. The driving unit is mounted in the housing, is adapted to be coupled to a tool bit, and is coupled electrically to the power supplying unit. The processor unit controls drive operation of the driving unit. The battery status indicator is mounted to the housing, is coupled electrically to the power supplying unit, and is controlled by the processor unit to generate a light output visible externally of the housing for visually indicating the status of the battery unit as monitored by the processor unit.

### CROSS-REFERENCE TO RELATED APPLICATION

This application claims priority of Taiwanese application no. 094214526, filed on Aug. 24, 2005.

### BACKGROUND OF THE INVENTION

1. Field of the Invention

The invention relates to a power tool, more particularly to a power tool capable of battery status indication.

2. Description of the Related Art

Battery-operated power tools for driving movably tool bits, such as drill bits, screw-driving bits, sockets, cutting blades, shearing blades, etc., are known in the art.

It is desirable to provide such power tools with a battery status indication capability so that the need to conduct charging of a battery unit can be indicated whenever appropriate, so that status of the battery unit can be indicated during charging, and so that the need to replace the battery unit can be indicated when the battery unit is damaged.

### SUMMARY OF THE INVENTION

Accordingly, a power tool of this invention comprises a housing, a battery-operated power supplying unit, a driving unit, and a battery status indicator.

The power supplying unit is mounted in the housing, is adapted to be connected to a battery unit, and includes a processor unit capable of monitoring status of the battery unit.

The driving unit is mounted in the housing, is adapted to be coupled to a tool bit, and is coupled electrically to the power supplying unit. The processor unit controls drive operation of the driving unit.

The battery status indicator is mounted to the housing, is coupled electrically to the power supplying unit, and is controlled by the processor unit to generate a light output visible externally of the housing for visually indicating the status of the battery unit as monitored by the processor unit.

### BRIEF DESCRIPTION OF THE DRAWINGS

Other features and advantages of the present invention will become apparent in the following detailed description of the preferred embodiments with reference to the accompanying drawings, of which:

FIG. 1 is an assembled perspective view of the first preferred embodiment of a power tool according to the present invention;

FIG. 2 is a schematic side view of the first preferred embodiment;

FIG. 3 is a functional block diagram of the first preferred embodiment; and

FIG. 4 is a schematic side view of the second preferred embodiment of a power tool according to the present invention.

### DETAILED DESCRIPTION OF THE PREFERRED EMBODIMENTS

Before the present invention is described in greater detail with reference to the accompanying preferred embodiments, it should be noted herein that like elements are denoted by the same reference numerals throughout the disclosure.

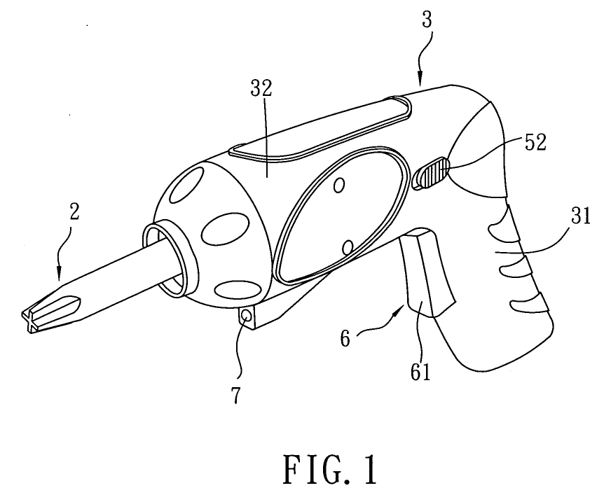

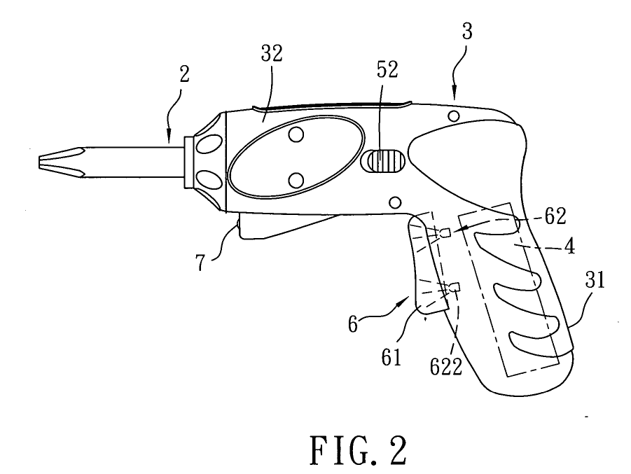

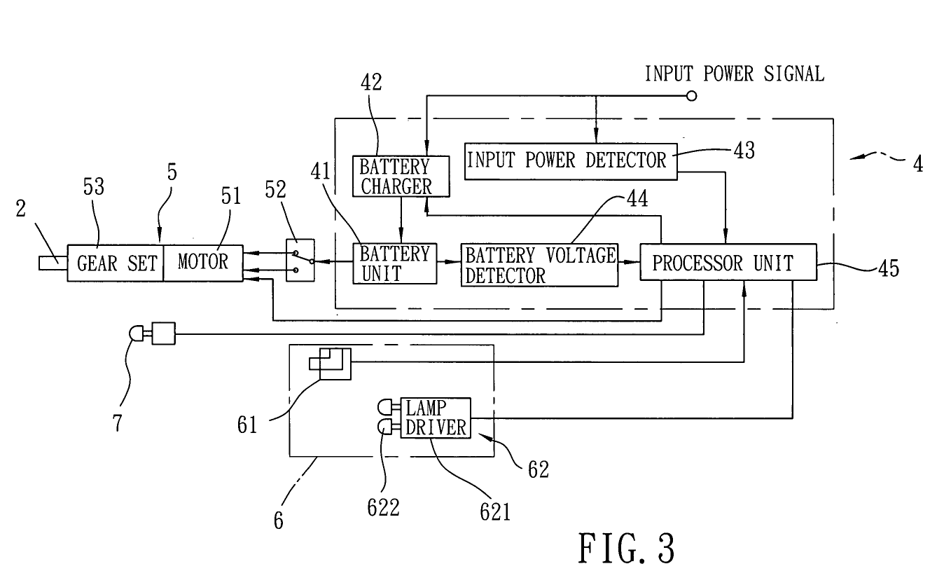

Referring to FIGS. 1 to 3, the first preferred embodiment of a power tool according to the present invention is shown to be adapted for driving a tool bit 2, such as a drill bit, a screw-driving bit, a socket, a saw blade, etc. This embodiment is illustrated using a screw-driving bit. The power tool includes a housing 3, a battery-operated power supplying unit 4 mounted in the housing 3, a driving unit 5 mounted in the housing 3, a battery status indicator 6 mounted to the housing 3, and an auxiliary lamp 7 mounted on the housing 3.

The housing 3 is in the form of a gun-shaped housing that is generally L-shaped in this embodiment, and includes a vertically extending handle portion 31 and a barrel portion 32 that extends forwardly from a top end of the handle portion 31.

The power supplying unit 4 is adapted to be connected to a battery unit 41 that is contained in the handle portion 31, and includes a processor unit 45 capable of monitoring status of the battery unit 41, a battery charger 42, an input power detector 43, and a battery voltage detector 44. The battery charger 42 is coupled electrically to the processor unit 45, is adapted to be connected electrically to the battery unit 41, and is operable so as to recharge the battery unit 41. In this embodiment, the processor unit 45 is operable so as to monitor charging operation of the battery charger 42. The input power detector 43 is coupled electrically to the processor unit 45, and is adapted for detecting supply of an input power signal to the battery charger 42. The processor unit 45 enables the battery charger 42 to recharge the battery unit 41 when the input power detector 43 detects the supply of the input power signal to the battery charger 42. The battery voltage detector 44 is coupled electrically to the processor unit 45, and is adapted for detecting battery voltage of the battery unit 41. In this embodiment, the processor unit 45 further controls the battery charger 42 to operate in one of a quick-charging mode and an intermittent-charging mode in accordance with the battery voltage detected by the battery voltage detector 44. For instance, when the voltage of the battery unit 41 is smaller than a predetermined level, the battery charger 42 is operated in the quick-charging mode. On the other hand, when the voltage of the battery unit 41 reaches the predetermined level, the battery charger 42 is operated in the intermittent-charging mode, in which a 0.2-second charging operation is conducted at three-second intervals, so as to protect the battery unit 41 from overcharging. In this embodiment, the battery unit 41 is a 3.6-volt lithium battery, and the processor unit 45 is a digital signal processor.

The driving unit 5 is adapted to be coupled to the tool bit 2, and is coupled electrically to the power supplying unit 4. The processor unit 45 controls drive operation of the driving unit 5. The driving unit 5 includes a motor 51 mounted in the barrel portion 32 of the housing 3, a direction control switch 52 in series connection between the motor 51 and the battery unit 41, and a gear set 53 coupled to and driven by the motor and adapted to be coupled to the tool bit 2. The switch 52 is operated to change polarity connections of the motor 51 to thereby change direction of rotation of the tool bit 2.

The battery status indicator 6 is coupled electrically to the power supplying unit 4, and is controlled by the processor unit 45 to generate a light output visible externally of the housing 3 for visually indicating the status of the battery unit 41 as monitored by the processor unit 45. In this embodiment, the battery status indicator 6 includes a user-actuated unit 61 and a lamp unit 62. Preferably, the user-actuated unit 61 includes a button made of a light-transmissible material and in the form of a gun trigger mounted operably to the handle portion 31 of the housing 3. The user-actuated unit 61 is coupled electrically to the processor unit 45, and enables the processor unit 45 to control the drive operation of the driving unit 5 upon manual operation of the button. The lamp unit 62 is mounted in the housing 3, and is coupled electrically to and controlled by the processor unit 45 so as to generate the light output that is directed to the button. In this embodiment, the processor unit 45 controls operation of the lamp unit 62 with reference to detector signals received from the input power detector 43 and the battery voltage detector 44. In this embodiment, the lamp unit 62 includes a lamp driver 621 coupled electrically to the processor unit 45, and first and second light-emitting diodes 622 coupled electrically to the lamp driver 621 and operable so as to emit different colors of light, respectively. In this embodiment, the first and second light-emitting diodes 622 emit red and blue light, respectively. In other embodiments, the first and second light-emitting diodes 622 may be replaced by a single light bulb or a single light-emitting diode.

The auxiliary lamp 7 is mounted on the barrel portion 32 of the housing 3, and is coupled electrically to the power supplying unit 4. When the driving unit 5 drives rotation of the tool bit 2, the auxiliary lamp 7 can be activated for illuminating a work area of the tool bit 2.

In this embodiment, through the input power detector 43 and the battery voltage detector 44, the processor unit 45 is able to monitor the state of the battery unit 41 as well as the charging operation of the battery charger 42, and to control the battery status indicator 6 to generate an appropriate light output for visually indicating the state of the battery unit 41 and/or the progress of the charging operation of the battery charger 42. For instance, when the battery unit 41 is being recharged by the battery charger 42, the processor unit 45 controls the lamp unit 62 to generate a continuous light output during operation of the battery charger 42 in the quick-charging mode, and to generate a slow flashing output (e.g., ON for 0.2 second every three-second interval) during operation of the battery charger 42 in the intermittent-charging mode. The slow flashing output is continued until the input power detector 43 no longer detects the input power signal.

When the button of the user-actuated unit 61 is manually operated while the battery voltage of the battery unit 41 is higher than a static preset value (such as 2.75 volts), which indicates sufficient residual power of the battery unit 41, aside from enabling drive operation of the driving unit 5, the processor unit 45 further activates both the lamp unit 62 and the auxiliary lamp 7 to generate light continuously. After a predetermined time period of about 30 seconds, the processor unit 45 deactivates the lamp unit 62 to conserve battery power. Thereafter, when the battery voltage of the battery unit 41 drops below a dynamic preset value (such as 2.45 volts), which indicates insufficient residual power of the battery unit 41, while the button of the user-actuated unit 61 is manually operated, the processor unit 45 deactivates the driving unit 5 and the auxiliary lamp 7, and controls the lamp unit 62 to flash for a predetermined number of times (such as two times), thereby indicating the need to recharge the battery unit 41.

The power tool of this embodiment is further able to indicate failure of the charging operation of the battery charger 42 due to a damaged battery unit 41. To this end, the processor unit 45 compares the battery voltages detected by the battery voltage detector 44 before recharging and 30 seconds into recharging. Upon detection of an abnormally large increase (e.g., more than 0.05 volt) in the battery voltage of the battery unit 41 during recharging, the processor unit 45 deems that the charging operation of the battery charger 42 has failed, stops further charging operation of the battery charger 42, and controls the lamp unit 62 to generate a blinking light output (e.g., three 0.1-second blinks per second) for indicating the need to replace the battery unit 41.

The power tool of this embodiment is also able to protect the driving unit 5 from overload. While the driving unit 5 is in an activated state, the processor unit 45 periodically monitors the battery voltage of the battery unit 41 (such as at three-second intervals) through the battery voltage detector 44. If the difference between two consecutive monitored values exceeds a threshold value (such as 0.55 volt), the processor unit 45 deems the driving unit 5 as being in an overloaded (or jammed) state and deactivates the same so as to prevent damage to the motor 51.

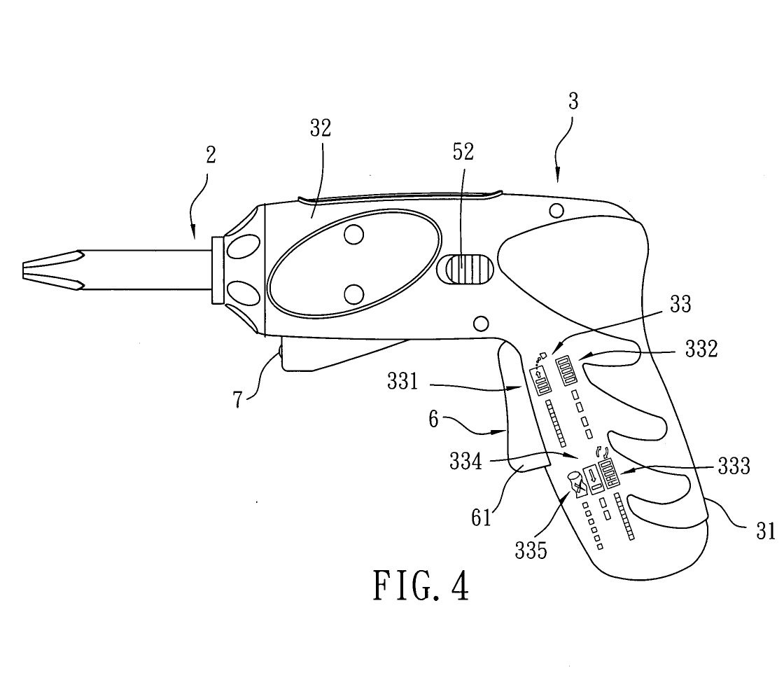

FIG. 4 illustrates the second preferred embodiment of this invention, which is a modification of the first preferred embodiment. In this embodiment, the handle portion 31 of the housing 3 has an outer surface formed integrally with illustrative indicia 33 to describe meanings associated with the light output of the battery status indicator 6. Preferably, the illustrative indicia 33 include five illustrations 331 to 335 to describe the meanings of five different light output patterns of the battery status indicator 6. In particular, the illustration 331 describes that the battery unit 41 is undergoing quick-charging when the battery status indicator 6 generates a continuous light output; the illustration 332 describes that the battery unit 41 is undergoing intermittent-charging when the battery status indicator 6 generates a slow flashing output; the illustration 333 describes that the battery unit 41 has sufficient residual power when the power tool is in a state of use and the battery status indicator 6 generates a continuous light output; the illustration 334 describes that the battery unit 41 has insufficient residual power when the power tool is in a state of use and the battery status indicator 6 generates a light output that flashes twice; and the illustration 335 describes that the battery unit 41 needs to be replaced when the battery status indicator 6 generates a blinking light output. In view of the illustrative indicia 33, the user is able to determine the status of the battery unit 41 without referring to a user's manual.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

I claim:

1. A power tool comprising:
a housing;
a battery-operated power supplying unit mounted in said housing, adapted to be connected to a battery unit, and including a processor unit capable of monitoring status of the battery unit;
a driving unit mounted in said housing, adapted to be coupled to a tool bit, and coupled electrically to said power supplying unit, said processor unit controlling drive operation of said driving unit; and
a battery status indicator mounted to said housing, coupled electrically to said power supplying unit, and controlled by said processor unit to generate a light output visible externally of said housing for visually indicating the status of the battery unit as monitored by said processor unit.

2. The power tool as claimed in claim 1, wherein said power supplying unit further includes a battery charger coupled electrically to said processor unit, adapted to be connected electrically to the battery unit, and operable so as to recharge the battery unit, said processor unit being operable so as to monitor charging operation of said battery charger.

3. The power tool as claimed in claim 2, wherein said battery status indicator includes:
a user-actuated unit including a button made of a light-transmissible material and mounted operably to said housing, said user-actuated unit being coupled electrically to said processor unit and enabling said processor unit to control the drive operation of said driving unit upon manual operation of said button; and
a lamp unit mounted in said housing and coupled electrically to said processor unit, said lamp unit being controlled by said processor unit so as to generate the light output that is directed to said button.

4. The power tool as claimed in claim 3, wherein said power supplying unit further includes:
an input power detector coupled electrically to said processor unit and adapted for detecting supply of an input power signal to said battery charger; and
a battery voltage detector coupled electrically to said processor unit and adapted for detecting battery voltage of the battery unit;
said processor unit controlling operation of said lamp unit with reference to detector signals received from said input power detector and said battery voltage detector.

5. The power tool as claimed in claim 4, wherein:
said processor unit controls said lamp unit to generate a continuous light output for a predetermined time period when said button is manually operated while residual power of the battery unit is sufficient; and
said processor unit controls said lamp unit to generate a light output that flashes for a predetermined number of times when said button is manually operated while the residual power of the battery unit is insufficient.

6. The power tool as claimed in claim 5, wherein said processor unit controls said lamp unit to generate a blinking light output when charging operation of said battery charger has failed.

7. The power tool as claimed in claim 6, wherein said processor unit deems that the charging operation of said battery charger has failed upon detection of an abnormally large increase in the battery voltage of the battery unit.

8. The power tool as claimed in claim 4, wherein said processor unit controls said battery charger to operate in one of a quick-charging mode and an intermittent-charging mode in accordance with the battery voltage detected by said battery voltage detector.

9. The power tool as claimed in claim 4, wherein said processor unit controls the drive operation of said driving unit with reference to magnitude of the battery voltage detected by said battery voltage detector.

10. The power tool as claimed in claim 3, wherein said housing has an outer surface provided with illustrative indicia to describe meanings associated with the light output of said battery status indicator.

11. The power tool as claimed in claim 10, wherein said housing includes a handle portion provided with said button and said illustrative indicia.

12. The power tool as claimed in claim 3, wherein said lamp unit includes a lamp driver coupled electrically to said processor unit, and first and second light-emitting diodes coupled electrically to said lamp driver and operable so as to emit different colors of light, respectively.

13. The power tool as claimed in claim 2, wherein said power supplying unit further includes:
an input power detector coupled electrically to said processor unit and adapted for detecting supply of an input power signal to said battery charger; and
a battery voltage detector coupled electrically to said processor unit and adapted for detecting battery voltage of the battery unit;
said processor unit controlling operation of said battery status indicator with reference to detector signals received from said input power detector and said battery voltage detector.

14. The power tool as claimed in claim 1, further comprising an auxiliary lamp mounted on said housing and coupled electrically to said power supplying unit for illuminating a work area of the tool bit.

15. The power tool as claimed in claim 1, wherein said driving unit includes a motor mounted in said housing, and a gear set coupled to and driven by said motor and adapted to be coupled to the tool bit.

16. The power tool as claimed in claim 1, wherein said housing has an outer surface provided with illustrative indicia to describe meanings associated with the light output of said battery status indicator.
